(19) United States
(12) Patent Application Publication
(10) Pub. No.: US 2023/0126290 A1
(43) Pub. Date: Apr. 27, 2023

(54) ION ACTIVATION AND FRAGMENTATION IN SUB-AMBIENT PRESSURE FOR ION MOBILITY AND MASS SPECTROMETRY

(71) Applicant: AGILENT TECHNOLOGIES, INC., Santa Clara, CA (US)

(72) Inventors: Ruwan T. KURULUGAMA, Livermore, CA (US); Kenneth R. NEWTON, Concord, CA (US)

(73) Assignee: AGILENT TECHNOLOGIES, INC., Santa Clara, CA (US)

(21) Appl. No.: 17/946,750

(22) Filed: Sep. 16, 2022

Related U.S. Application Data
(60) Provisional application No. 63/271,070, filed on Oct. 22, 2021.

(51) Int. Cl. H01J 49/14; H01J 49/04; H01J 49/40

(52) U.S. Cl. CPC H01J 49/14; H01J 49/0495; H01J 49/0422; H01J 49/403

(57) ABSTRACT

An ion source may include an ionization chamber to be maintained at atmospheric-pressure. The ion source may further include a reduced-pressure chamber to be maintained at sub-atmospheric pressure, and an ion transfer device comprising an inlet in the ionization chamber and an outlet in the reduced-pressure chamber. The ion transfer device may define an ion path from the inlet to the outlet. The ion transfer device may be positioned to emit ions and neutral gas molecules from the outlet as an expanding beam comprising a low-gas density zone enveloped by a high-gas density region that includes a gas density that is higher than the low-gas density zone. The ion source may be utilized, for example, for ion mobility spectrometry (IMS), mass spectrometry (MS), and hybrid IM-MS.

### PRIORITY

This application claims priority to commonly assigned and co-pending U.S. Provisional Application Ser. No. 63/271,070, filed Oct. 22, 2021, the disclosure of which is hereby incorporated by reference in its entirety.

### TECHNICAL FIELD

The present invention relates generally to ion mobility spectrometry (IMS), mass spectrometry (MS), and ion mobility-mass spectrometry (IM-MS), and more specifically to the development and implementation of ion activation in IMS, MS, and IM-MS systems.

### BACKGROUND

A mass spectrometry (MS) system in general includes an ion source for ionizing components of a sample under investigation, a mass analyzer for separating gas-phase ions based on their differing mass-to-charge ratios (or m/z ratios, or more simply “masses”), an ion detector for counting the separated ions, and electronics for processing output signals from the ion detector as needed to produce a user-interpretable mass spectrum. Typically, the mass spectrum may include a series of peaks indicative of the relative abundance of detected ions as a function of their m/z ratios. The mass spectrum may be utilized to determine the molecular structures of components of the sample, thereby enabling the sample to be qualitatively and quantitatively characterized. One type of MS may include a time-of-flight mass spectrometer (TOF MS). A TOF MS may utilize a high-resolution mass analyzer (TOF analyzer). Ions may be transported from the ion source into a TOF entrance region through a series of ion guides, ion optics, and various types of ion processing devices. The TOF analyzer may include an ion accelerator that injects ions in packets (or pulses) into an electric field-free flight tube. In the flight tube, ions of differing masses may travel at different velocities and thus separate (e.g., spread out) according to their differing masses, enabling mass resolution based on time-of-flight.

Ion mobility spectrometry (IMS) may represent a gas-phase ion separation technique in which ions produced from a sample in an ion source are separated based on their differing mobilities through a drift cell of known length that is filled with an inert gas of known composition and maintained at a known gas pressure and temperature. In low-electric field drift-type IMS, the ions are urged forward through the drift cell under the influence of a relatively weak, uniform direct current (DC) voltage gradient, for example in a range from 10 V/cm to 20 V/cm. The mobility of the ions may depend on their collision cross-sections (CCSs), and thus their size and conformation or shape, charge states (e.g., +1, +2, or +3), and to a relatively lesser extent on their m/z ratios. Thus, ion separation by IM may be relatively different from ion separation by MS. From the drift cell the ions may ultimately arrive at an ion detector, and the output signals from the ion detector may be processed to generate peak information useful for distinguishing among the different analyte ion species detected. If the time that ions spent in the drift tube region is known and also the pressure and the voltage across the drift tube are known, then the CCS can be determined for any ion of interest. The CCS parameter may be specific for a given molecule and instrument independent, and therefore can be utilized as a unique parameter for compound identification. Hence, the CCS parameter may be relevant to structural characterization of molecules and theoretical molecular dynamic simulations, as well as to some other disciplines of science.

An IMS system may be coupled online with a mass analyzer, which may be a TOF analyzer. In the combined IM-MS system, ions may be separated by mobility prior to being transmitted into the mass analyzer where they are then mass-resolved. Due to the differences between IM-based separation and MS-based separation, performing the two separation techniques in tandem may be particularly useful in the analysis of complex chemical mixtures, including high-molecular weight (MW) biomolecules (e.g., biopolymers) such as polynucleotides, proteins, carbohydrates and the like. For example, the added dimension provided by the IM separation may help to separate ions that are different from each other (e.g., in shape) but present overlapping mass peaks. On the other hand, the added dimension provided by the MS separation may help to separate ions that have different masses but similar CCSs. This hybrid IM-MS separation technique may be further enhanced by coupling it with liquid chromatography (LC) or gas chromatography (GC) techniques. An IM-MS system may thus be capable of acquiring multi-dimensional IM-MS data from a sample, characterized by acquisition time (e.g., chromatographic time or retention time), ion abundance (e.g., ion signal intensity), ion drift time through the IM drift cell, and m/z ratio as sorted by the MS.

An ion may be activated through collision with a neutral gas molecule with a high enough collision energy to result in collisional heating, as opposed to collisional cooling, of the ion. With a high enough collision energy (CE), ion activation can fragment the ion. This mechanism of ion fragmentation may be implemented in a collision cell, and may be referred to as collision-induced dissociation (CID) or collision-activated dissociation (CAD). Ion activation may also be utilized to cause a folded protein ion or other large biomolecular ion to unfold, which may be referred to as collision-induced unfolding (CIU). Depending on the magnitude of the collision energy, CIU may or may not be accompanied by fragmentation/dissociation. Ion activation followed by ion mobility separation may be used to identify closely related ions that can be difficult to identify using other techniques including IM or MS alone.

Two techniques for generating gas-phase ions may include electrospray ionization (ESI) and matrix-assisted laser desorption ionization (MALDI), both of which may represent atmospheric-pressure ionization (API) techniques. For MS and IMS, gas phase ions may need to be generated with minimum or no solvent molecules, and adducts may need to be attached to the analyte ions. In-source ion activation, methods coupled to ESI or MALDI techniques can provide fully desolvated gas-phase ions. Both MS and IMS may benefit from in-source ion activation and fragmentation techniques performed prior to the mass and/or ion mobility analysis, such as by enhancing the elucidation of gas-phase ion structure. For folded molecules, the above-noted CIU technique induced by ion activation may enable improved molecular structure analysis. Therefore, in-source ion activation and fragmentation may be utilized for MS, IMS, and hybrid IM-MS applications.

MS, IMS, and hybrid IM-MS instruments may not include an ion activation mechanism in the ion source that can achieve enough energy to unfold larger biomolecules or de-cluster larger biomolecules. Commercial mass spectrometers may be equipped with a capillary-skimmer interface that couples the atmospheric pressure ionization region of the ion source with the first vacuum region in the mass spectrometer to allow moderate ion activation. Such a capillary-skimmer interface may not be able to provide high enough energy for collisional activation or fragmentation of larger bio-molecules. The typical pressure in a capillary-skimmer interface may be less than 1 Torr. At higher pressures, this capillary-skimmer interface may not be able to provide high enough collision energy before electrical discharge. Therefore, larger bio-molecules may not be activated, fragmented or unfolded using a capillary-skimmer interface. In some applications, a dopant gas may be added (e.g., nitrogen added as a dopant to helium buffer gas) to allow somewhat higher collision energies before electrical discharge, but such an approach may be inadequate. The problem of achieving high collision energies while avoiding electrical discharge is addressed in U.S. Pat. No. 9,916,968 to Kurulugama et al., the entire disclosure of which is incorporated by reference herein, and which is directed to in-source ion activation.

Mass spectrometers that employ an ion funnel interface to couple the atmospheric pressure ionization region with the high vacuum region do not have a capillary-skimmer interface. Instead, the capillary may be directly connected to a sub-atmospheric pressure region of the vacuum chamber containing an ion funnel apparatus. Here the capillary could be inline or orthogonal to the ion funnel axis. When the capillary is orthogonal to the ion funnel axis, an ion deflector plate may be used to direct ions into the ion funnel. For a capillary-ion funnel interface, it may be more challenging to achieve ion activation due to the high pressure at which ion funnels are operated, as well as due to the mechanical design.

There continues to be a need for providing improved in-source ion activation, unfolding, and fragmentation in a high-pressure region of a mass spectrometer or another analytical device such as a stand-alone ion mobility spectrometer, or in a hybrid IM-MS instrument. There is also a need for providing improved desolvation and declustering of analyte ions prior to mass spectrometry analysis.

### SUMMARY

To address the foregoing needs, in whole or in part, and/or other needs that may have been observed by persons skilled in the art, the present disclosure provides methods, processes, systems, apparatus, instruments, and/or devices, as described by way of example in implementations set forth below.

This disclosure provides apparatus and methods for ion activation, including for molecular ion unfolding and/or fragmentation, in IMS, MS, and IM-MS systems. Examples disclosed herein may allow for higher excitation levels than achieved by previously known apparatus and methods. Examples disclosed herein may achieve this by enabling the deposition of an increased amount of internal energy in the ions, in comparison to previously known apparatus and methods.

According to examples disclosed herein, an ion source may include an ionization chamber to be maintained at atmospheric-pressure. The ion source may further include a reduced-pressure chamber to be maintained at sub-atmospheric pressure, and an ion transfer device comprising an inlet in the ionization chamber and an outlet in the reduced-pressure chamber. The ion transfer device may define an ion path from the inlet to the outlet. The ion transfer device may be positioned to emit ions and neutral gas molecules from the outlet as an expanding beam comprising a low-gas density zone enveloped by a high-gas density region that includes a gas density that is higher than the low-gas density zone.

According to examples disclosed herein, an ion source may include an atmospheric-pressure ionization chamber, a reduced-pressure chamber configured for maintaining a sub-atmospheric pressure therein, and an ion transfer device comprising an inlet in the ionization chamber and an outlet in the reduced-pressure chamber, and defining an ion path from the inlet to the outlet. The ion transfer device may be configured to emit ions and neutral gas molecules from the outlet as an expanding beam comprising a low-gas density zone enveloped by a high-gas density region having a gas density higher than the low-gas density zone. An electrode may be positioned in the reduced-pressure chamber at a gap distance from the outlet. The outlet and the electrode may be configured to generate an electric field therebetween to accelerate ions emitted from the outlet to a collision energy that is effective to induce ion activation of ions in the reduced-pressure chamber without voltage breakdown. Further, the outlet and the electrode may be configured to position the electric field in overlapping relation to the low-gas density zone.

For the ion source described above, the reduced-pressure chamber may be configured to maintain the sub-atmospheric pressure in a range from about 0.5 Torr to about 30 Torr.

The ion source described above may further include a vacuum system configured to reduce the reduced-pressure chamber to the sub-atmospheric pressure.

For the ion source described above, the gap distance may be in a range of between about 0.5 mm to about 5 mm.

For the ion source described above, the outlet may be positioned on an outlet axis, and the electrode may include an aperture positioned on the outlet axis.

For the ion source described above, the electrode may include a cylindrical section defining the aperture.

For the ion source described above, the outlet and the electrode may include respective inside diameters that are substantially equal.

For the ion source described above, the outlet and the electrode may be configured to control the expanding beam such that the low-gas density zone transitions to a Mach disk located at or in the aperture.

For the ion source described above, the ion transfer device may include a main bore having an inside diameter smaller than an inside diameter of the outlet, and a conical section fluidly coupling the main bore to the outlet. The conical section may include an inside diameter that increases from the inside diameter of the main bore to the inside diameter of the outlet.

For the ion source described above, the ion transfer device may include a capillary tube through which the main bore extends, and a cap mounted to or part of the capillary tube. The cap may include the conical section and the outlet.

For the ion source described above, the conical section and the outlet may be configured to control the expanding beam such that the low-gas density zone extends from the outlet to the electrode.

The ion source described above may further include a voltage source configured to impart a potential difference between the outlet and the electrode to generate the electrical field.

For the ion source described above, the voltage source may be configured to impart the potential difference in a range from about 0 V to about 1000 V.

For the ion source described above, the potential difference across the electric field may be specified to be high enough to raise the collision energy to a value effective to promote desolvation of solvated ions emitted from the outlet. Alternatively or additionally, the potential difference across the electric field may be specified to be high enough to raise the collision energy to a value effective to promote declustering of cluster ions emitted from the outlet. Alternatively or additionally, the potential difference across the electric field may be specified to be high enough to raise the collision energy to a value effective to unfold folded (bio)molecular ions emitted from the outlet by collision-induced unfolding. Alternatively or additionally, the potential difference across the electric field may be specified to be high enough to raise the collision energy to a value effective to unfold folded (bio)molecular ions emitted from the outlet by collision-induced unfolding without dissociating the (bio)molecular ions. Alternatively or additionally, the potential difference across the electric field may be specified to be high enough to raise the collision energy to a value effective to dissociate ions emitted from the outlet by collision-induced dissociation.

The ion source described above may further include an ion guide in the reduced-pressure chamber positioned along an ion guide axis.

For the ion source described above, the ion guide may be configured to generate a radio frequency electric field effective for limiting radial motion of ions relative to the ion guide axis.

For the ion source described above, the ion guide may be configured to generate a direct-current potential gradient along the ion guide axis.

For the ion source described above, the ion guide may include an ion guide entrance and an ion guide exit spaced from the ion guide entrance along the ion guide axis. The ion guide entrance may surround at least a portion of the electrode.

For the ion source described above, the ion guide may include an ion funnel.

For the ion source described above, the ion guide may include a plurality of ion guide electrodes spaced from each other along the ion guide axis. The ion guide electrodes may include a plurality of respective ion guide apertures.

For the ion source described above, the outlet may be positioned on an outlet axis radially offset from the ion guide axis.

For the ion source described above, the ion guide may be specified as a first ion guide and the ion guide axis may be specified as a first ion guide axis. The ion source may further include a second ion guide positioned along a second ion guide axis and configured to receive ions from the first ion guide.

For the ion source described above, the second ion guide may be configured to generate an electric field effective for trapping ions in the second ion guide for a controllable period of time.

For the ion source described above, the second ion guide may include an ion funnel.

For the ion source described above, the second ion guide may include a plurality of ion guide electrodes spaced from each other along the ion guide axis. Further, the ion guide electrodes may include a plurality of respective ion guide apertures.

For the ion source described above, the second ion guide axis may be radially offset from the first ion guide axis.

The ion source described above may further include an ionization device configured to produce ions in the ionization chamber from a sample by atmospheric-pressure ionization.

For the ion source described above, the reduced-pressure chamber may not include a skimmer.

According to examples disclosed herein, a spectrometry system may include an ionization chamber to be maintained at atmospheric-pressure. A reduced-pressure chamber may be maintained at sub-atmospheric pressure. An ion transfer device may include an inlet in the ionization chamber and an outlet in the reduced-pressure chamber. The ion transfer device may define an ion path from the inlet to the outlet. An electrode may be positioned in the reduced-pressure chamber at a gap distance from the outlet.

According to examples disclosed herein, a spectrometry system may include an ion source according to any of the examples disclosed herein. Further, the spectrometry system may include a vacuum housing configured to receive ions from the reduced-pressure chamber, and an ion analyzer in the vacuum housing.

For the spectrometry system described above, the ion analyzer may include an ion mobility drift cell or a mass analyzer.

For the spectrometry system described above, the ion analyzer may represent a first ion analyzer. The spectrometry system may further include a second ion analyzer configured to receive ions from the first ion analyzer.

For the spectrometry system described above, the first ion analyzer may be an ion mobility drift cell and the second ion analyzer may be a mass analyzer.

For the spectrometry system described above, the first ion analyzer may be an ion mobility drift cell. Further, the second ion analyzer may be a mass spectrometer including a first mass analyzer, a collision cell configured to receive ions from the first mass analyzer, and a second mass analyzer configured to receive ions from the collision cell.

According to examples disclosed herein, a method for analyzing a sample may include performing atmospheric-pressure ionization to produce ions from the sample in an ionization chamber. The method may further include transferring the ions from the ionization chamber to a reduced-pressure chamber maintained at a sub-atmospheric pressure. Further, the method may include subjecting the ions emitted into the reduced-pressure chamber to an electric field that accelerates the ions to a collision energy that is effective to induce ion activation of the ions without voltage breakdown.

According to examples disclosed herein, a method for analyzing a sample may include performing atmospheric-pressure ionization to produce ions from the sample in an ionization chamber. The method may further include transferring the ions from the ionization chamber to a reduced-pressure chamber maintained at a sub-atmospheric pressure. The ions and neutral gas molecules may be emitted into the reduced-pressure chamber as an expanding beam comprising a low-gas density zone enveloped by a high-gas density region having a gas density higher than the low-gas density zone. Further, the method may include subjecting the ions emitted into the reduced-pressure chamber to an electric field that accelerates the ions to a collision energy. The collision energy may be effective to induce ion activation of the ions without voltage breakdown. The electric field may be positioned in overlapping relation to the low-gas density zone.

For the method described above, the method may further include maintaining the reduced-pressure chamber at a pressure in a range of between about 0.5 Torr to about 30 Torr.

For the method described above, the transferring of the ions may include emitting the ions from an outlet of an ion transfer device. Further, subjecting the ions to the electric field may include imparting a potential difference between the outlet and an electrode in the reduced-pressure chamber to accelerate the ions to the collision energy.

For the method described above, transferring of the ions may include controlling the expanding beam such that the low-gas density zone transitions to a Mach disk located at or in the aperture.

The method described above may further include applying the electric field at a potential difference in a range from about 0 V to about 1000 V.

For the method described above, the collision energy may be selected from a collision energy effective to promote desolvation of solvated ions emitted from the outlet, a collision energy effective to promote declustering of cluster ions emitted from the outlet, a collision energy effective to unfold folded biomolecular ions emitted from the outlet by collision-induced unfolding, a collision energy effective to unfold folded biomolecular ions emitted from the outlet by collision-induced unfolding without dissociating the biomolecular ions, and/or a collision energy effective to dissociate ions emitted from the outlet by collision-induced dissociation.

For the method described above, the transferring of the ions may include emitting the ions into an ion guide positioned in the reduced-pressure chamber.

For the method described above, the ion guide may include an ion funnel.

The method described above may further include, after transferring the ions into the reduced-pressure chamber, transferring the ions into an ion analyzer.

For the method described above, the ion analyzer may include an ion mobility drift cell or a mass analyzer.

For the method described above, the ion analyzer may represent a first ion analyzer. The method may further include transferring the ions from the first ion analyzer to a second ion analyzer.

For the method described above, the first ion analyzer may represent an ion mobility drift cell and the second ion analyzer may represent a mass analyzer.

The method described above may further include, after transferring the ions into the reduced-pressure chamber, transferring the ions into an ion mobility drift cell and subsequently to an ion detector.

The method described above may further include measuring respective arrival times of the ions at the ion detector relative to a time at which the ions were transferred into the ion mobility drift cell.

The method described above may further include, calculating, based on the measured arrival times, an arrival time distribution of the ions, and/or calculating collision cross-sections of the ions.

For the method described above, the ions transferred into the reduced-pressure chamber may include folded biomolecular ions. The collision energy may be effective to unfold the folded biomolecular ions, and the measuring of respective arrival times may include measuring respective arrival times of the unfolded ions.

For the method described above, the collision energy may be effective to produce fragment ions by collision-induced dissociation, and the measuring of respective arrival times may include measuring respective arrival times of the fragment ions.

The method described above may further include, after transferring the ions into the reduced-pressure chamber, transferring the ions into a mass analyzer and subsequently to an ion detector to produce a mass spectrum of the ions.

For the method described above, the collision energy may be effective to produce fragment ions by collision-induced dissociation. The method may further include producing a mass spectrum of the fragment ions.

The method described above may further include, after transferring the ions into the reduced-pressure chamber, transferring the ions into an ion mobility drift cell, followed by transferring the ions into the mass analyzer.

The method described above may further include, after transferring the ions to the ion detector, producing an ion mobility drift time spectrum and a mass spectrum of the ions.

For the ion source and method described above, the overlapping relation may correspond to the electric field overlapping with 50% or greater, or 60% or greater, or 70% or greater, or 80% or greater, or 90% or greater, or 100%, of the low-gas density zone.

According to examples disclosed herein, a spectrometry system may include at least one processor and a memory configured to perform all or part of any of the methods disclosed herein.

According to examples disclosed herein, a spectrometry system may include a controller, and an ion detector communicating with the controller. The spectrometry system may be configured to perform all or part of any of the methods disclosed herein.

According to examples disclosed herein, a non-transitory computer-readable storage medium may include instructions to perform all or part of any of the methods disclosed herein.

According to examples disclosed herein, a system may include the computer-readable storage medium.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a spectrometry system or instrument according to an example disclosed herein.

FIG. 2A is a schematic perspective view of an outlet end of an example of an ion transfer device according to an example disclosed herein.

FIG. 2B is a schematic cross-sectional view of the outlet end of the ion transfer device illustrated in FIG. 2A, and also an electrode utilized for ion activation/fragmentation according to an example disclosed herein.

FIG. 2C is another schematic cross-sectional view of the outlet end of the ion transfer device and electrode illustrated in FIG. 2B, also schematically illustrating an example of the structure of the gas/ion flow and the electric field applied between the outlet end and the electrode.

FIG. 3 is a schematic view of an example of a spectrometry system or instrument according to another example disclosed herein.

FIG. 4A shows an ion mass spectrum for tune mix ions acquired from operating an IM-qTOF instrument with in-source ion activation voltage set to 0 V.

FIG. 4B shows a fragment ion mass spectrum spectral data for a sample acquired from operating an IM-qTOF instrument having a previously known configuration, with the in-source ion activation voltage set to 400 V.

FIG. 4C shows a fragment ion mass spectrum spectral data for the same sample as pertains to FIG. 4B, acquired from operating an IM-qTOF instrument having a configuration as disclosed herein, with the in-source ion activation voltage set to 400 V.

### DETAILED DESCRIPTION

In this disclosure, the term “about” when modifying a specified numerical value is taken to encompass a range of values that include +/−10% of such numerical value.

The present disclosure describes apparatuses and methods for improved ion activation and fragmentation and collision-induced unfolding (CIU) of molecules, including proteins and other biomolecules, for structural analysis in conjunction with mass spectrometry (MS), ion mobility spectrometry (IMS), and hybrid ion mobility-mass spectrometry (IM-MS) instrumentation. The apparatuses and methods described herein provide high ion activation energies in high gas pressure regions (e.g., about 0.5 Torr to about 30 Torr), which allow unfolding of large molecules such as proteins and biomolecules, including large native proteins such as monoclonal antibodies. According to an aspect of the present disclosure, such high ion activation energies may be achieved in high gas pressure regions while avoiding voltage breakdown, and further without the need to add dopant gases to the ion source region. The ion activation and unfolding may be implemented, for example, prior to ion mobility separation with or without coupling to mass spectrometry, or prior to mass spectrometry analysis without prior ion mobility separation. The ion activation may also be utilized to improve de-solvation and de-clustering of gas-phase ions prior to ion mobility separation with or without mass spectrometry analysis, or prior to mass spectrometry analysis without prior ion mobility separation. The ion activation may also be implemented prior to ion mobility separation to enable the determination of arrival time distribution or collision cross section (CCS) changes that accompany ion unfolding patterns for (bio)molecules.

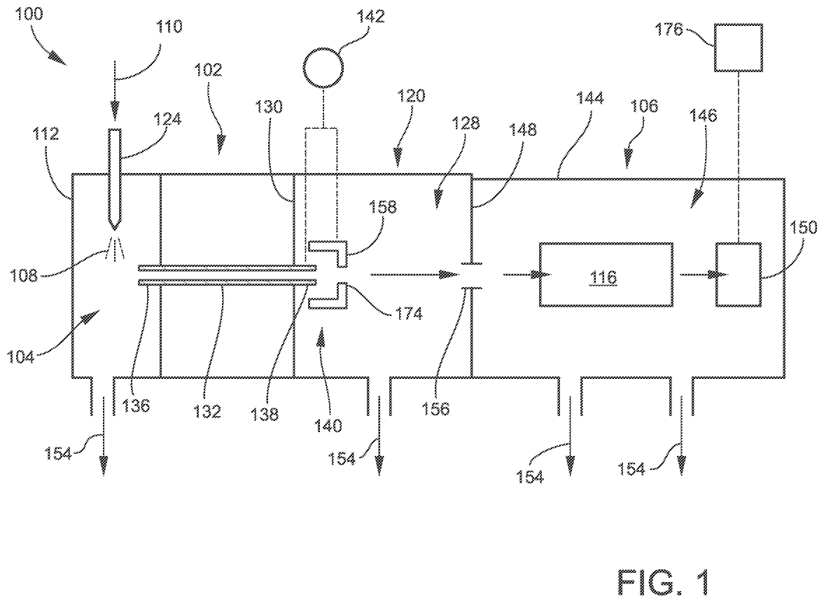

FIG. 1 is a schematic view of an example of a spectrometry system or instrument 100 according to an example. The operation and design of various components of spectrometry systems, including mass spectrometry (MS), ion mobility spectrometry (IMS), and hybrid ion mobility-mass spectrometry (IM-MS) systems, are generally known to persons skilled in the art and thus need not be described in detail herein. Instead, certain components are briefly described to facilitate an understanding of the subject matter presently disclosed.

The spectrometry system 100 may generally include, in series of ion process flow, an ion source 102 configured to produce gas-phase ions 108 from a sample 110 introduced into the ion source 102, and a spectrometer 106 configured to receive ions from ion source 102 and process the ions as needed to produce analytical data descriptive of the ions and thus components of the original sample 110. Horizontal arrows in FIG. 1 indicate the general or resultant direction of ions through the spectrometry system 100.

The ion source 102 may generally include an outer housing 112 enclosing an ionization chamber 104 in which ions 108 are produced, and an ion source-spectrometer interface 120 configured to receive the ions and transfer the ions into the spectrometer 106. One or more ionization devices 124 may be configured (and positioned) to ionize components of the sample 110 in the ionization chamber 104. The ionization chamber 104 may be maintained at (or about) atmospheric pressure. The interface 120 may include one or more reduced-pressure chambers 128 (or a chamber with one or more reduced-pressure regions) configured to reduce the gas pressure relative to the ionization chamber 104, and collect and compress the ions as a beam in preparation for transferring the ions into the spectrometer 106. One or more internal walls 130 may provide a physical boundary between the ionization chamber 104 and the (first) reduced-pressure chamber 128. The reduced-pressure chamber 128 may be maintained at a reduced pressure, also referred to herein as a (high) sub-atmospheric pressure. In the present context, a high sub-atmospheric pressure may refer to a pressure that is lower than the pressure maintained in the ionization chamber 104, but higher than the vacuum level of pressure maintained in the spectrometer 106. As one non-limiting example, the high sub-atmospheric pressure may be in a range from about 0.5 Torr to about 30 Torr.

The ion source 102 may further include an ion transfer device 132 configured (and positioned) to transfer ions (and neutral gas molecules) from the ionization chamber 104 to the reduced-pressure chamber 128. For this purpose, the ion transfer device 132 may include an inlet 136 fluidly communicating with the ionization chamber 104 and an outlet 138 fluidly communicating with the reduced-pressure chamber 128. The ion transfer device 132 may extend from the inlet 136, through one or more internal walls 130 between the ionization chamber 104 and the reduced-pressure chamber 128, and to the outlet 138. The ion transfer device 132 may thus define an ion path from the inlet 136 to the outlet 138, and emit a stream of ions and neutral gas molecules from the outlet 138. The ion source 102 may further include an electrode assembly 140 positioned in the reduced-pressure chamber 128. A voltage source 142, provided by appropriate electronics of the spectrometry system 100, may be in electrical communication with the outlet 138 of the ion transfer device 132 and the electrode assembly 140. Representative examples of the ion transfer device 132 and the electrode assembly 140 are described in more detail below.

The spectrometer 106 may generally include an outer housing (or vacuum housing) 144 configured to receive ions from the reduced-pressure chamber 128. The vacuum housing 144 may enclose one or more vacuum chambers 146. An ion analyzer 116 and an ion detector 150 may be positioned in at least one of the vacuum chambers 146. In one example, the spectrometer 106 may be a mass spectrometer (MS) configured to produce ion mass (m/z) spectra, in which case the ion analyzer 116 may include at least one mass analyzer. In another example, the spectrometer 106 may be an ion mobility spectrometer (IS) configured to produce ion drift spectra and calculate ion collision cross-section (CCS), in which case the ion analyzer 116 may include at least one ion mobility (IM) drift cell. In FIG. 1, the ion analyzer 116 may also be schematically representative of other ion processing devices, which may include additional ion analyzers. Thus, in another example, the spectrometer 106 may be a hybrid ion mobility-mass spectrometry (IM-MS) instrument configured to produce two-dimensional IM-MS spectral data. In this case, the ion analyzer 116 may include a first ion analyzer followed by a second ion analyzer configured to receive ions from the first ion analyzer. The first ion analyzer may be an IM drift cell and the second ion analyzer may be a mass analyzer.

In another example, an ion fragmentation device may be positioned between the first ion analyzer and the second ion analyzer, enabling the spectrometer 106 to produce fragment ion spectra. In this case, the first ion analyzer may be a mass analyzer (e.g., a mass filter) configured to select precursor ions for fragmentation, and the second ion analyzer may be a (final) mass analyzer configured to mass-resolve product ions produced from the precursor ions in the ion fragmentation device. In another example, the spectrometer 106 may include an IM drift cell followed by a mass analyzer, followed by an ion fragmentation device, and followed by a (final) mass analyzer. In another example, the IM drift cell may be configured as a trapped ion mobility spectrometry (TIMS) tunnel, which may be configured to selectively release the ions from the ion funnel according to their mobility. In another example, the configuration of the IM portion of the instrument may be based on Structures for Lossless Ion Manipulation (SLIM) technology. The SLIM device may include one or more linear segments, each defined by a pair of planar boards (e.g., printed circuit boards or PCBs). Each board may include a combination of flat DC guard electrodes and RF/DC electrodes (or, additionally, RF-only electrodes) configured to confine the ions and push the ions forward through the SLIM device. One or more SLIM segments may be operated to promote collisional activation and/or to create an ion accumulation (store and release) region within the SLIM device. Multiple SLIM segments may be arranged in a serpentine manner to increase the ion path length through the SLIM device. See, e.g., Tolmachev et al., Characterization of Ion Dynamics in Structures for Lossless Ion Manipulations, Anal. Chem. 2014, 86, 9162-9168; May et al. Resolving Power and Collision Cross Section Measurement Accuracy of a Prototype High-Resolution Ion Mobility Platform Incorporating Structures for Lossless Ion Manipulation, J. Am. Soc. Mass Spectrom. 2021, 32, 1126-1137; Arndt et al., High-Resolution Ion-Mobility-Enabled Peptide Mapping for High-Throughput Critical Quality Attribute Monitoring, doi.org/10.1021/jasms.0c00434, J. Am. Soc. Mass Spectrom. (2021), the entire contents of each of which are incorporated by reference herein. Other high-resolution IM (HRIM) devices, now known or later developed, may also be suitable for examples disclosed herein.

At least one internal wall 148 may provide a physical boundary between the (last) reduced-pressure chamber 128 of the ion source 102 and the (first) vacuum chamber 146 of the spectrometer 106. Depending on the types of ion processing devices operating in the spectrometer 106 and the number of distinct vacuum chambers 146 provided, different vacuum levels may be maintained in different regions of the vacuum housing 144. For example, an IM drift cell may be “pressurized” to a drift gas pressure in a range from, for example, 1 to 10 Torr. More generally, an IM drift cell may be configured to operate at pressures up to atmospheric pressure. Accordingly, an IM drift cell located in the spectrometry system 100 may operate in a range from about 1 Torr to about 760 Torr. On the other hand, a mass analyzer may operate at a pressure in a range from, for example, 10⁻⁴ to 10⁻⁹ Torr. The spectrometry system 100 may include a vacuum system configured to maintain the various regions of the spectrometry system 100 at the required pressure levels and remove non-analytical neutral molecules from the ion path, as schematically represented in FIG. 1 by arrows 154 and associated ports communicating with corresponding chambers. For this purpose, the vacuum system may include various components (ports, conduits, pumps, etc.) as appreciated by persons skilled in the art.

An opening 156 through the wall 148 may provide a path to transit ions into the vacuum chamber 146. Various ion optics may define or be positioned near the opening 156. For example, a skimmer cone (or sampling cone) may be positioned at or define the opening 156. While a skimmer cone could be provided in examples disclosed herein, a skimmer cone may not be needed, as will become evident from further description herein.

Generally, the ion transfer device 132 may take on various forms. In a typical example contemplated for the present disclosure, the ion transfer device 132 may be or may include a capillary tube. The geometry of a capillary tube may be desirable for various reasons. The small diameter of the bore of a capillary tube may act as a gas conductance barrier that facilitates maintaining a pressure differential between the higher-pressure ionization chamber 104 and the lower-pressure reduced-pressure chamber 128, and may reduce the amount of gas molecules transferred into the reduced-pressure chamber 128 with the ions. In addition, the length of a capillary tube may provide an opportunity for desolvation and declustering of ions and evaporation of neutral droplets to occur in the capillary tube. Such mechanisms may be enhanced by providing a heating device (not shown) in thermal contact with the capillary tube. In some examples, the capillary tube may be composed of glass. In some examples, the capillary tube may include resistive or conductive elements at or near the inlet 136 and the outlet 138 to enable a potential difference to be imparted across the capillary tube.

In some examples and as described further below, the ion transfer device 132 may include an end cap structure mounted to an outlet end of a capillary tube. The end cap structure may be electrically conductive and receive a (typically electrostatic) voltage potential from voltage source 142. The end cap structure may also be configured (e.g., shaped, sized, positioned) to modulate or control the gas/ion stream emitted from the ion transfer device 132 in a manner described below.

The electrode assembly 140 may include at least one electrode 158 (or counter-electrode, also referred to herein as an ion activation electrode or fragmentation electrode) positioned in the reduced-pressure chamber 128 at a predetermined axial gap distance (or outlet-electrode distance) from the outlet 138 (e.g., capillary exit) of the ion transfer device 132. In the present context, the term “axial” may relate to the longitudinal axis along which the ion transfer device 132 is arranged, which also generally corresponds to the axis along which the ions travel from the outlet 138. The electrode 158 may include an electrode aperture 174 positioned on-axis at the predetermined axial gap distance. As a non-limiting example, the gap distance (the axial distance between the outlet 138 and the electrode 158) may be in a range from about 0.5 mm to about 5 mm. The electrode assembly 140 may also include one or more structural components (e.g., electrically insulating components) as needed for mounting the electrode 158 in a fixed position in the reduced-pressure chamber 128, routing wiring to the electrode 158, etc., as appreciated by persons skilled in the art.

The voltage source 142 may be configured to impart a predetermined potential difference between the ion transfer device 132 (e.g., the outlet 138 thereof) and the electrode 158 to accelerate ions emitted from the outlet 138 to a predetermined collision energy at which the ions collide with neutral gas molecules in the reduced-pressure chamber 128. The magnitude of the potential difference may be selected so that the collision energy is effective to cause collisional heating/activation of ions in the reduced-pressure chamber 128 without voltage breakdown, for a given pressure and outlet-electrode distance. As non-limiting examples, the voltage source 142 may be configured to impart the potential difference in a range from about 0 V to about 1000 V, or from about 0 V to about 500 V.

The magnitude of the potential difference may be selected so that the collision energy is effective to implement a desired modality of ion activation. As examples, the collision energy may be raised or adjusted to a value effective to promote desolvation of solvated ions emitted from the outlet 138, and/or to promote declustering of cluster ions emitted from the outlet 138. Additionally, the collision energy may be raised or adjusted to a value effective to dissociate ions emitted from the outlet 138 by collision-induced dissociation (CID). Additionally, the collision energy may be raised or adjusted to a value effective to unfold folded (bio)molecular ions emitted from the outlet 138 by collision-induced unfolding (CIU), with or without also dissociating the biomolecular ions, as desired in a particular application. According to an aspect of the present disclosure, electrode assembly 140 may be configured to enable all such modalities to be carried out in a high-pressure environment, for example in a range from about 0.5 Torr to about 30 Torr as specified elsewhere herein, without causing undesirable electrical discharge by voltage breakdown. The outlet-electrode distance may be set or adjusted as needed to prevent voltage breakdown in view of the ranges of pressure and collision energies contemplated for a given application, and/or to optimize conditions for a particular modality of ion activation.

The configuration of the ion transfer device 132 and the electrode assembly 140 may allow obtaining a relatively high electric field at the outlet 138 (e.g., capillary exit) of the ion transfer device 132, improving certain collision-based activities in comparison to conventional ionization-spectrometer interfaces, and enabling other collision-based activities not practical or possible in conventional ionization-spectrometer interfaces. The ion transfer device 132 and the electrode assembly 140 may operate in a higher pressure regime in comparison to conventional capillary-skimmer interfaces. A skimmer may not be needed in examples of the present disclosure.

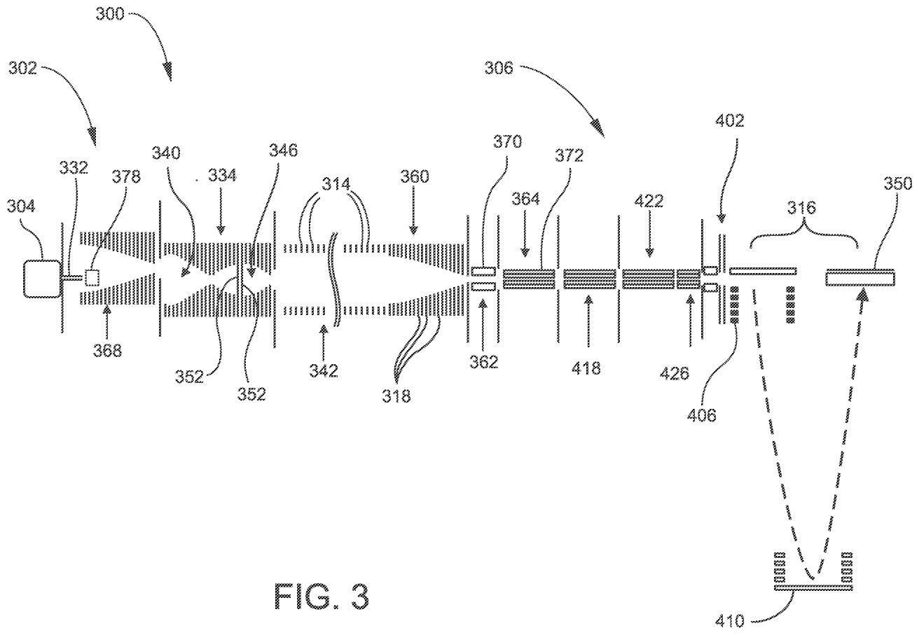

The ion transfer device 132 and the electrode assembly 140 may operate in conjunction with other ion processing devices provided in the reduced-pressure chamber(s) 128, such as ion guides and ion funnel-based devices such as described below in conjunction with FIG. 3. An ion guide in the reduced-pressure chamber may be configured to generate a radio frequency electric field effective for limiting radial motion of ions relative to an ion guide axis, and/or for generating a direct-current potential gradient along the ion guide axis. The ion guide may include an ion guide entrance and an ion guide exit spaced from the ion guide entrance along the ion guide axis. The ion guide entrance may surround at least a portion of the electrode assembly 140. The outlet 138 of the ion transfer device 132 may be positioned on an outlet axis radially offset from the ion guide axis. The ion guide may include a plurality of ion guide electrodes spaced from each other along the ion guide axis and including a plurality of respective ion guide apertures. The ion guide may include or be configured as an ion funnel, or as another type of stacked-ring ion guide such as an S-lens. Another example may be a conjoined ion guide that may include two stacked-ring ion guides having different diameters. The axes of the two stacked-ring ion guides may be parallel, but offset, to each other such that one stacked-ring ion guide is positioned above the other stacked-ring ion guide. The ring electrodes of the two stacked-ring ion guides may be slotted, e.g., they are not complete rings but instead have open gaps. The gaps of the lower stacked-ring ion guide may face upward, and the gaps of the upper stacked-ring ion guide may face downward and thus face the gaps of the lower stacked-ring ion guide. Ions may enter the lower stacked-ring ion guide and shift upward through the gaps and into the upper stacked-ring ion guide, under the influence of a DC potential difference.

The reduced-pressure chamber(s) 128 may include a plurality of ion guides, such as a first ion guide positioned along a first ion guide axis and a second ion guide positioned along a second ion guide axis and configured to receive ions from the first ion guide. The second ion guide may be configured to generate an electric field effective for trapping ions in the second ion guide for a controllable period of time. The second ion guide may include or be configured as an ion funnel. The second ion guide may include a plurality of ion guide electrodes spaced from each other along the ion guide axis and including a plurality of respective ion guide apertures. The second ion guide axis may be radially offset from the first ion guide axis.

In addition, the ion transfer device 132 and the electrode assembly 140 may operate in conjunction with operating a separate collision cell in the spectrometer 106. Methods may be developed for the use of both the electrode assembly 140 and a collision cell for ion activation to yield additional information regarding ions not possible or readily ascertainable from the use of either the electrode assembly 140 or the collision cell alone.

The spectrometry system 100 may also include a controller (or system controller, or computing device) 176 configured to control or monitor various components and functions of the spectrometry system 100. For example, the controller 176 may control, or execute a preprogrammed operation of the voltage source 142 and consequently control the electric fields and collision energies realized in the reduced-pressure chamber 128 of the ion source 102.

An example of a method for analyzing a sample will now be described with reference to FIG. 1. The ion source 102 may be operated to perform atmospheric-pressure ionization to produce ions from the sample in the ionization chamber 104. The ions may be transferred into the reduced-pressure chamber 128, which may be maintained at a relatively high sub-atmospheric pressure, via the ion transfer device 132. In the reduced-pressure chamber 128, the ions may be subjected to an electric field that accelerates the ions to a collision energy through operation of the voltage source 142 and electrode assembly 140. The collision energy may be effective to cause collisional heating of the ions in the reduced-pressure chamber 128 without voltage breakdown. The collision energy may be set to a value effective to perform a desired processing of the ions emitted from the outlet 138 of the ion transfer device 132 and into the reduced-pressure chamber 128. Examples may include promoting desolvation of solvated ions, promoting declustering of cluster ions, fragmenting ions by collision-induced dissociation, and unfolding folded biomolecular ions by collision-induced unfolding (with or without also fragmenting the ions). The collision energy may be set by controlling the electric field, which may be generated by imparting a potential difference between the ion transfer device 132 and the electrode assembly 140. The potential difference may be, for example, in a range from about 0 V to about 1000 V.

In one example, after transferring the ions into the reduced-pressure chamber 128, the ions may be transferred into an ion mobility drift cell of the spectrometer 106 to separate the ions by mobility. The separated ions may then be transferred to the ion detector 150. The ion detector 150 may be utilized to measure respective arrival times of the ions at the ion detector 150 relative to a time at which the ions were transferred into the ion mobility drift cell. Based on the measured arrival times, an arrival time distribution of the ions and/or collision cross-sections of the ions may be calculated. In the case of folded (bio)molecular ions, these ions may first be unfolded in the reduced-pressure chamber 128 as described above, and the arrival times of the unfolded ions may be measured. As also described above, fragment ions may be produced in the reduced-pressure chamber 128, and the arrival times of the fragment ions may be measured.

In another example, after transferring the ions into the reduced-pressure chamber 128, the ions may be transferred into a mass analyzer of the spectrometer 106 to separate the ions by mass-to-charge (m/z) ratio. The separated ions may then be transferred to the ion detector 150. The signals outputted from ion detector 150 may be utilized to produce a mass spectrum of the ions, which may be fragment ions produced in the reduced-pressure chamber 128 as described above.

In another example, after transferring the ions into the reduced-pressure chamber 128, the ions may be transferred into an ion mobility drift cell and then into a mass analyzer of the spectrometer 106. In this way, both an ion mobility drift time spectrum and a mass spectrum of the ions may be produced.

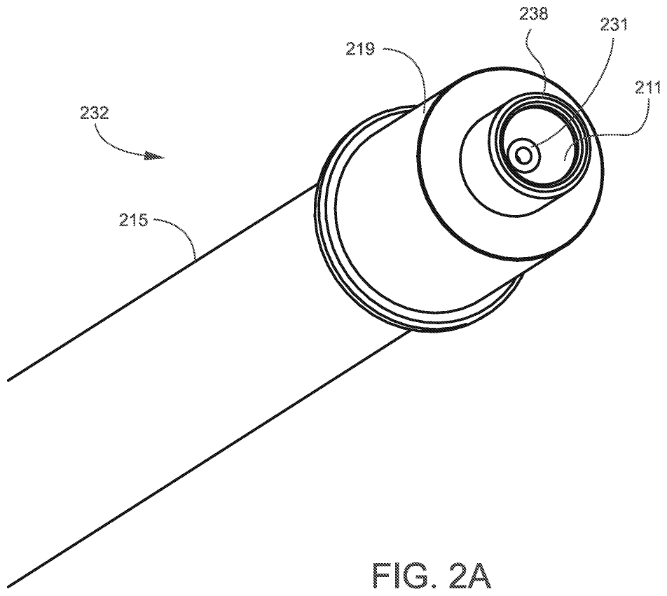

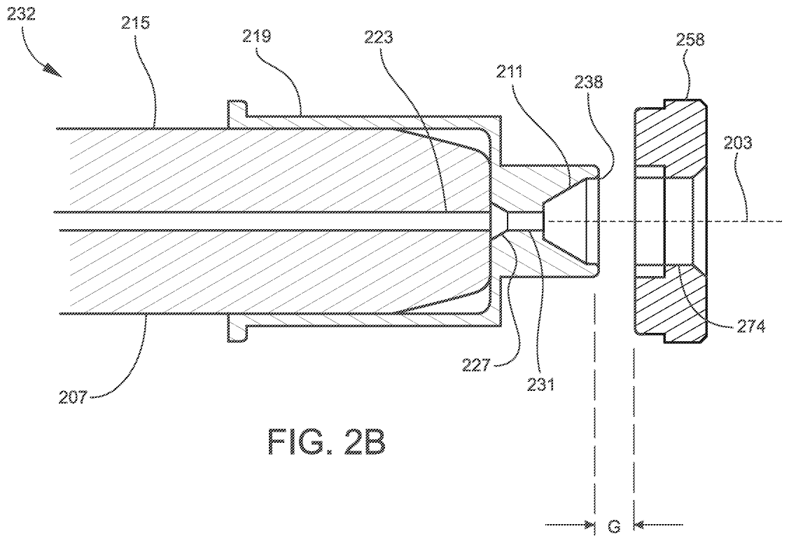

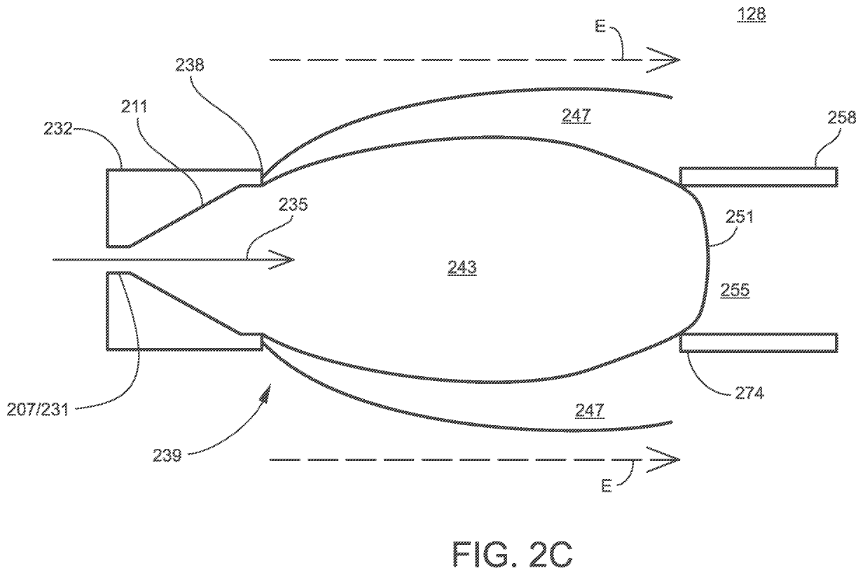

FIG. 2A is a schematic perspective view of an outlet end of an example of an ion transfer device 232 according to an example. FIG. 2B is a schematic cross-sectional view of the outlet end of the ion transfer device 232 and also an electrode 258 utilized for ion activation/fragmentation. These components are illustrated as they would be positioned relative to each other in a reduced-pressure chamber 128 of an ion source-spectrometer interface 120, as described above in conjunction with FIG. 1.

The ion transfer device 232 may include an outlet 238 located on an outlet axis 203. The electrode 258 may also be positioned on the outlet axis 203 and may be axially spaced from the outlet 238 by a gap distance G (also referred to herein as the outlet-electrode distance). In particular, the electrode 258 may include an electrode aperture 274 positioned on the outlet axis 203 at the gap distance G. In one non-limiting example, the gap distance G may be in a range from about 0.5 mm to about 5 mm. In operation, a stream (or spray) of ions and neutral gas molecules may be emitted from the outlet 238 and pass through the electrode aperture 274 toward the entrance (e.g., opening 156, FIG. 1) of the spectrometer 106. The ions and gas molecules may be driven through the ion transfer device 232 under the influence of the pressure differential between the ionization chamber 104 and the reduced-pressure chamber 128 (FIG. 1). The ions may also be directed into the inlet 136 (FIG. 1) of the ion transfer device 232 by an appropriately positioned electric field applied in the ionization chamber 104, and may be urged through the ion transfer device 232 by an electric field applied across the length of the ion transfer device 232. Upon exiting the outlet 238, the ions may be accelerated toward and through the electrode aperture by an electric field applied between the outlet 238 and the electrode 258 (e.g., by the voltage source 142 shown in FIG. 1).

In the present example, the ion transfer device 232 may include a main bore 207 that fluidly intercouples the inlet 136 (in the ionization chamber 104, FIG. 1) and the outlet 238. The main bore 207 may run straight along the outlet axis 203. The inside diameter of the main bore 207 may be in a range from 0.3 mm to 1.5 mm. Also in the present example, the ion transfer device 232 may include a conical section 211 that fluidly couples the main bore 207 and the outlet 238. The inside diameter of the entrance into the conical section 211 may be equal to, or substantially equal to (e.g., +/−0.3 mm), the inside diameter of the main bore 207. The conical section 211 may taper or diverge outwardly in the direction toward the electrode 258. That is, the inside diameter of the conical section 211 may increase in the direction toward the electrode 258, from the inside diameter of the main bore 207 to the inside diameter of the outlet 238. The inside diameter of the outlet 238 may be in a range from 2 mm to 5 mm. The conical section 211 and the outlet 238 may function as a diverging nozzle. As shown in FIG. 2B, the inside diameter of the outlet 238 may be equal to, or substantially equal to (e.g., +/−0.3 mm), the inside diameter of the electrode aperture 274. By this configuration, the conical section 211 and the outlet 238 may optimize the fluid mechanics of the gas/ion stream emitted from the outlet 238, as described further below.

In the present example, the ion transfer device 232 may include a capillary tube 215 and a capillary cap 219. The main bore 207 may be formed through the capillary tube 215 and terminate at a main bore outlet 223, which may be the outlet of the capillary tube 215. The capillary cap 219 may be mounted to the outlet end of the capillary tube 215 in any suitable manner. The conical section 211 may be formed in the capillary cap 219, and the outlet of the capillary cap 219 may be the outlet 238 of the ion transfer device 232. The capillary cap 219 may include a cap inlet 227 fluidly communicating with the main bore outlet 223. The capillary cap 219 may also include a straight bore section 231 that fluidly intercouples the cap inlet 227 and the conical section 211. The inside diameter of the straight bore section 231 may be equal to, or substantially equal to (e.g., +/−0.6 mm), the inside diameter of the main bore 207. The capillary cap 219 may be composed of a metal or metal alloy, or other suitable electrically conductive material, and may be composed of a material different from that of the capillary tube 215. In use, the capillary cap 219 may be electrically coupled to the voltage source 142 (FIG. 1) so that an electrostatic potential can be applied to the capillary cap 219 to generate the electric field between the outlet 238 and the electrode 258.

In another example, the capillary cap 219 may be part of, or integrated with, the capillary tube 215, for example as a single-piece construction. Stated differently, the outlet end of the capillary tube 215 may be configured to include the features of the capillary cap 219 (e.g., conical section 211, ion transfer device outlet 238) and a separate capillary cap 219 may not be utilized.

FIG. 2C is another schematic cross-sectional view of the outlet end of the ion transfer device 232 and the ion activation electrode 258, also schematically illustrating an example of the structure of the gas/ion flow and the electric field applied between the outlet 238 and the electrode 258. In an example, a gas/ion stream 235 may exit the main bore 207 (or straight bore section 231) and the outlet 238 at or near a supersonic speed (M>1) and at a pressure that is different from the pressure of the reduced-pressure chamber 128. Upon exiting the main bore 207 (or straight bore section 231), the gas/ion flow may undergo supersonic expansion and its supersonic speed increases. Accordingly, the gas/ion stream 235 may exit the outlet 238 in the form of an expanded (or expanding) beam 239. Depending on the pressure of the exiting gas/ion stream 235 and the pressure at which the reduced-pressure chamber 128 is being held, the expanded beam 239 may be overexpanded or underexpanded as appreciated by persons skilled in the art. During emission of the gas/ion stream 235, an electric field E may be applied between the outlet 238 and the electrode 258 to accelerate the ions toward the electrode 258 and to a desired collision energy that is effective to induce ion activation of the ions without voltage breakdown (electrical discharge), as described above.

The expanded beam 239 may include a low-gas density zone 243 (also referred to as a “silent zone” or “zone of silence”) located on the outlet axis, and one or more high-gas density regions 247 that coaxially surround or envelop the low-gas density zone 243. The structure of the high-gas density region(s) 247 may be in the form of a “barrel shock,” as appreciated by persons skilled in the art. Here, the terms “low” and “high” may be relative to each other. That is, the gas density of the high-gas density region(s) 247 may be higher than the gas density of the low-gas density zone 243. The gas density of the high-gas density region(s) 247 may also be higher than the gas density of the surrounding interior of the reduced-pressure chamber 128. In one non-exclusive example, the gas density of the low-gas density zone 243 may be in a range from 0.1 Torr to 2 Torr, and the gas density of the high-gas density region(s) 247 may be in a range from 1 Torr to 30 Torr. The speed of the gas in the low-gas density zone 243 may be the highest (M>>1), while the speed of the gas in the high-gas density region(s) 247 may be lower yet still supersonic (M>1). The low-gas density zone 243 may abruptly transition (or terminate) at another high-gas density region whose shock structure may be oriented generally normal (perpendicular) to the outlet axis and net direction of gas/ion flow. This high-gas density region may be characterized as a “Mach disk,” “shock diamond,” or “normal shock (wave)” 251, as appreciated by persons skilled in the art. Beyond the Mach disk 251, the gas speed may be subsonic (M<1).

The low-gas density zone 243, as determined based on analysis of the spectrometry system 100, may be advantageous for implementing ion activation (with or without ion fragmentation). The ions exiting the outlet 238 of the ion transfer device 232 may be accelerated through the low-gas density zone 243 by the applied electric field E. Because the gas density in the low-gas density zone 243 is low, the ions may be accelerated to higher translational energies between each collision with the flowing gas molecules. Consequently, the collision energies achieved by the presently disclosed example may be higher in comparison to previously known configurations of an ion transfer device and associated counter-electrode, and hence the ion excitation (of internal energy states) may be significantly higher in comparison to previously known configurations. Moreover, the bulk excitation and fragmentation efficiency may be enhanced by positioning the electric field E in overlapping relation to the low-gas density zone 243 (or, equivalently, positioning the low-gas density zone 243 in overlapping relation to the electric field E). Increasing the extent of this overlap may maximize the benefits gained from accelerating the ions through the low-gas density zone 243, i.e., allowing the deposition of increased internal energy in the ions at the available pressures and voltages. Depending on the example disclosed herein, the electric field E may entirely overlap with the low-gas density zone 243 (i.e., the low-gas density zone 243 may be completely immersed in the electric field E, or the electric field E overlaps with 100% of the low-gas density zone 243), or substantially overlap with the low-gas density zone 243. In the present context, “substantial overlap” may mean that the electric field E overlaps with greater than 50% of the low-gas density zone 243 (or at least the portion of the low-gas density zone 243 located beyond the outlet 238, given that the low-gas density zone 243 may begin inside the conical section 211 of the ion transfer device 232). In other examples, the electric field E may overlap with 60% or greater, or 70% or greater, or 80% or greater, or 90% or greater of the low-gas density zone 243.

Accordingly, in an example, the outlet 238 (and associated conical section 211, if provided) and the electrode 258 may be configured (e.g., positioned, shaped, sized, etc.) to position the electric field E in overlapping relation to the low-gas density zone 243. In particular, the gap distance G between the outlet 238 and the electrode 258 (FIG. 2B) may be set to maximize the overlap. Moreover, the outlet 238 (and associated conical section 211, if provided) may be configured (e.g., positioned, shaped, sized, etc.) to control the shape or structure of the expanded beam 239 to contribute to maximizing the overlap with the electric field E. In a further example, as schematically depicted in FIG. 2C, the outlet 238 and the electrode 258 may be configured to locate the Mach disk 251 at or in the electrode aperture 274, thereby ensuring that the low-gas density zone extends fully from the outlet 238 to the electrode 258. At the Mach disk 251 and beyond, the gas density may abruptly increase (e.g., compared to the low-gas density zone 243). Hence, this configuration may establish a highly effective ion activation zone 255 at or inside the electrode aperture 274, where the probability of collisions between the accelerated ions (which also may be highly energetic due to the interactions occurring in the low-gas density zone 243) and gas molecules may be greatly increased.

FIG. 3 is a schematic view of an example of a spectrometry system or instrument 300 according to another example. The spectrometry system 300 may generally include an ion source 302 and a spectrometer 306, which in the present example may be an IM-MS spectrometer and more specifically an IM-qTOF spectrometer. As in FIG. 1, the general direction of ion process flow may be from left to right.

In the present example, the ion source 102 may include, in series of ion process flow, an ionization chamber 304 and an ion transfer device in the form of a capillary tube 332 leading into an ion source-spectrometer interface. A capillary cap (not shown) as described above in conjunction with FIGS. 2A-2C may also be provided. The interface may include a first reduced-pressure chamber containing a high-pressure ion funnel 368, and a second reduced-pressure chamber containing an accumulating/pulsing ion trap 334. As one non-limiting example, the high sub-atmospheric pressure at which the interface operates may be in a range from about 0.5 Torr to about 30 Torr. As another example, the high-pressure ion funnel 368 in the first reduced-pressure chamber may operate at a pressure in a range from about 2 Torr to about 30 Torr, and the ion trap 334 in the second reduced-pressure chamber may operate at a pressure in a range from about 1 Torr to about 20 Torr. As a further example, the ion funnel 368 may operate at a pressure of about 5.0 Torr and the ion trap 334 may operate at a pressure of about 4.0 Torr.

In the present example, the high-pressure ion funnel 368 and the ion trap 334 may be configured as ion funnels that include respective series of axially spaced funnel electrodes in the form of rings or plates with apertures, as appreciated by persons skilled in the art. Radio-frequency (RF) potentials may be applied to the funnel electrodes in a manner that constrains the radial motions of the ions and thereby compresses the ion beam along the respective longitudinal axes of the high-pressure ion funnel 368 and the ion trap 334, and direct-current (DC) potentials may be applied to the funnel electrodes so as to generate an axial DC voltage gradient to keep the ions moving in a forward direction, again as appreciated by persons skilled in the art. The ion trap 334 may include a converging entrance region 378 and a diverging/constant-diameter/converging trap region 346. Electrostatic grid electrodes 352 in the trap region 346 may be utilized to alternately trap ions in the trap region 346 and pulse ions (periodically release the ions in packets, or pulses) into the spectrometer 306. The high-pressure ion funnel 368 may be oriented non-coaxially with the ion trap 334, with the axis of the high-pressure ion funnel 368 being offset from (as illustrated) or at an angle to that of the ion trap 334. This configuration may be useful for reducing the amount of neutral species entering the trap region 346 and improving ion transmission into the trap region 346. A similar dual ion funnel system is further described in U.S. Pat. No. 8,324,565, the entire contents of which are incorporated by reference herein.

The ion source 102 further may include an electrode assembly 340 positioned proximate to the outlet of the capillary tube 332, and configured according to any of the examples described herein. The capillary tube 332 may extend a small distance into the entrance end of the high-pressure ion funnel 368, and thus the electrode assembly 340 may be positioned in the entrance end of the high-pressure ion funnel 368. The voltage between the capillary exit and the first funnel entrance electrode of the high-pressure ion funnel 368 may be about 50 V. Based on this mechanical design, it may be challenging to obtain a high enough electric field at the capillary exit to result in collision-induced ion activation for larger biomolecules. However, the electrode assembly 340 may be operated in the entrance region of the high-pressure ion funnel 368 to readily enable collision-induced ion activation as described herein.

In the present example, the spectrometer 306 may include, in series of ion process flow, an IM analyzer (drift cell) 342, a rear ion funnel 360 immediately following the drift cell 342, one or more linear multipole ion guides 362 and 364 (e.g., hexapoles, octopoles, etc.) and/or other ion optics following the rear ion funnel 360, a quadrupole mass filter 418 for selecting ions, a linear multipole-based collision cell 422 for producing fragment ions, an ion beam compressor 426, entrance optics 402, a time-of-flight (TOF) analyzer 316, and an ion detector 350. Alternatively, the mass filter 418 (or an additional mass filter) may precede the IM drift cell 342.

The drift cell 342 may include a plurality of drift cell electrodes 314 spaced along the longitudinal axis of the drift cell 342. In one non-limiting example, the drift cell 342 may be 0.78 m in length, operate at a drift gas (e.g., nitrogen) pressure in a range from about 1 Torr to about 10 Torr (e.g., about 4 Torr), and apply a typically uniform drift axial DC electric field gradient of 20 V/cm. The axial field gradient may move the ions through the drift cell 342 in the presence of the drift gas, whereby the ions become separated in time based on their different collision cross-sections (CCSs) as appreciated by persons skilled in the art. The controller 176 (FIG. 1) may calculate the “drift time” taken by each ion to traverse the length of the drift cell 342 based on the arrival time of the ion measured at the ion detector 350. The time scale of IM separation may be typically milliseconds (ms). The rear ion funnel 360 may include a plurality of axially spaced funnel electrodes 318, which apply RF and axial DC fields as described above. The rear ion funnel 360 may receive the IM-separated ions and transmit the IM-separated ions onward into the spectrometer 306.

The multipole ion guides 362 and 364 may include respective sets of axially elongated guide electrodes 370 and 372 circumferentially spaced about the respective longitudinal axes of the multipole ion guides 362 and 364. The guide electrodes 370 and 372 may apply RF fields to focus ions along the axes as described above. As a non-limiting example, the multipole ion guides 362 and 364 may operate at pressures in a range from 10⁻³ to 10⁻⁵ Torr.

The quadrupole mass filter 418 may include a set of four parallel rod-shaped electrodes positioned at a radial distance from the central axis of the mass filter 418, and circumferentially spaced from each other around the central axis so as to surround an axially elongated interior mass filter volume leading from an ion entrance end to an axially opposite ion exit end of the mass filter 418. The mass filter 418 may apply a composite RF/DC field tuned to allow selected ions to pass through its ion exit end and further into the spectrometer 306. The mass filter 418 may thus operate as a bandpass mass filter in which the operating parameters of the RF/DC field dictate the width (Δm/z) of the m/z passband, as well as the low m/z cutoff value and the high m/z cutoff value of the m/z passband. During some sample runs, or during some periods of time in a given sample run, the mass filter 418 may be operated as an RF-only ion guide without actively filtering the ion transmission.

The collision cell 422 may include a linear multipole electrode configuration, and may be pressurized with a collision gas (e.g., argon, nitrogen, etc.) to a pressure effective for CID, for example, about 10 mTorr. RF potentials applied to the collision cell electrodes may focus the ions toward the central axis of the collision cell 422, while an axial DC voltage applied across the length of the collision cell 422 may push the ions forward through the collision cell 422. Precursor ions (or “parent” ions) colliding with the collision gas molecules with sufficient energy may fragment into fragment ions (or “product” or “daughter” ions). As noted above, the collision cell 422 may be actively operated as an ion fragmentation device in addition to operating the electrode assembly 340 in the ion source 302. During some sample runs, or during some periods of time in a given sample run, the collision cell 422 may be operated as an RF-only ion guide without actively inducing ion fragmentation.

The ion beam compressor 426 may include a set of multipole electrodes converging toward the axis to enhance beam compression and provide efficient ion transmission.

In the present example, the TOF analyzer 316 may include an ion accelerator 406, an evacuated (e.g., 10⁻⁴ to 10⁻⁹ Torr) TOF flight tube (not shown) oriented orthogonally to the entrance optics 402 and an electric field-free TOF flight region, an ion detector 350, and an electrostatic reflectron (or ion mirror, or Mamyrin mirror) 410. The reflectron 410 may provide a 1800 reflection in the ion flight path in the flight tube between the ion accelerator 406 and the ion detector 350, thereby extending the length of the flight path and correcting the kinetic energy distribution of the ions. The region containing the entrance optics 402 may be pumped down to the vacuum level of the flight tube. In operation, the ion accelerator 406 may accelerate (e.g., inject) discrete packets of ions into the flight tube at a predetermined pulsing rate (or firing rate). The TOF injection pulses typically occur on a much faster time scale (microseconds (μs)) than the IM injection pulses (milliseconds (ms)). As the TOF injection rate (frequency) may be typically relatively higher than the IM injection rate (frequency), many TOF injection pulses may occur during the period between two sequential IM injection pulses. Each ion packet injected into the flight tube may include a range of ion masses, depending on how the preceding mass filter 418 and collision cell 422 are being operated. In each ion packet, ions of different masses (m/z ratios) may travel through the flight tube at different velocities and thus have different overall times-of-flight, e.g., ions of smaller masses travel faster than ions of larger masses. Thus, each ion packet may spread out (e.g., is dispersed) in space in accordance with the time-of-flight distribution. The ion detector 350 may detect and record the time that each ion arrives at (e.g., impacts) the ion detector 350. A data acquisition process implemented by the controller 176 (FIG. 1) may correlate the recorded times-of-flight with m/z ratios.

It will be understood that FIGS. 1-3 may be high-level schematic depictions of an example of a spectrometry system and associated components consistent with the present disclosure. Other components, such as additional structures, vacuum pumps, gas plumbing, ion optics, ion guides, electronics, and computer-related or electronic processor-related components may be included as needed for practical implementations.

### Examples

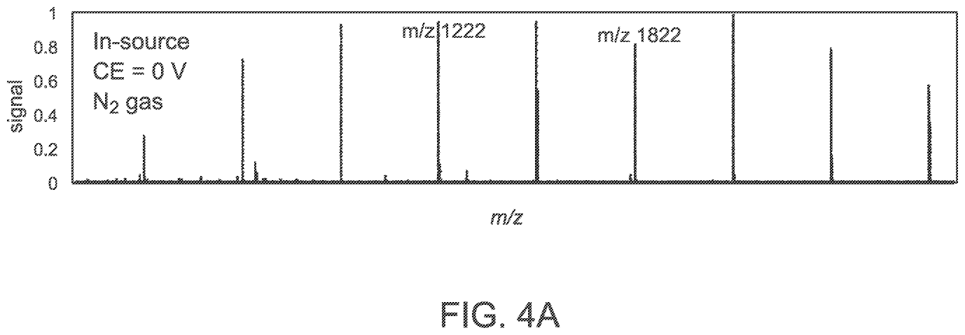

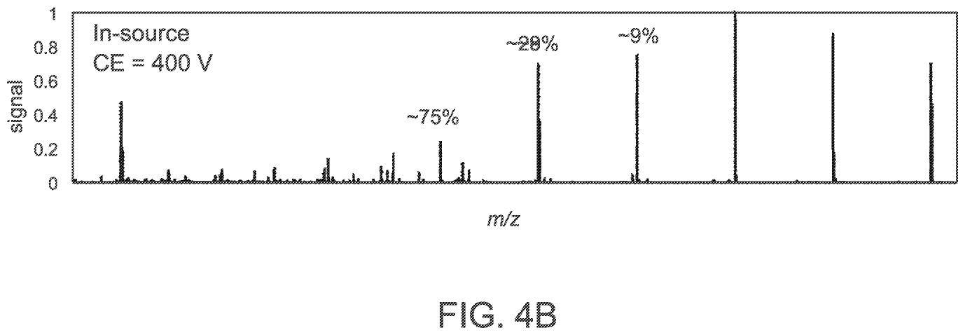

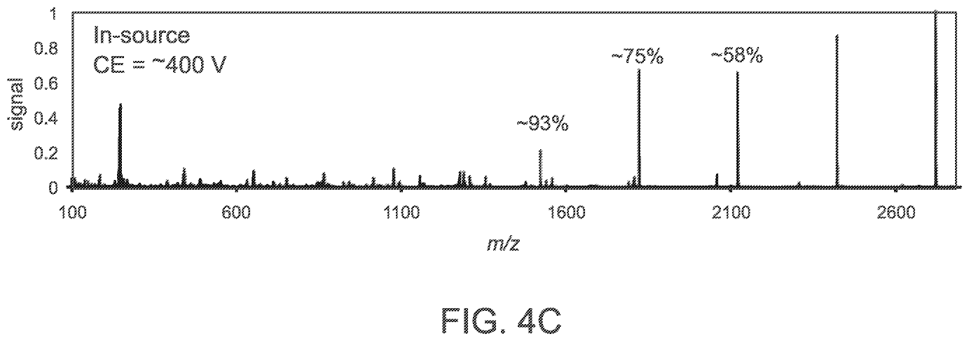

FIG. 4A shows an ion mass spectrum for tune mix ions acquired from operating an IM-qTOF instrument with in-source ion activation voltage set to 0 V. This may be the condition where ions were not subjected to ion fragmentation. The in-source ion activation voltage may be the voltage applied to the capillary outlet and the fragmentor lens, which increases collision energy (CE) and thereby allows ion acceleration to induce ion activation and fragmentation. FIG. 4B shows a fragment ion mass spectrum for the same tune mix ions acquired from operating an IM-qTOF instrument having a previously known configuration, with the in-source ion activation voltage set to 400 V. FIG. 4C shows a fragment ion mass spectrum for the same tune mix ions acquired from operating an IM-qTOF instrument having a configuration as disclosed herein, with the in-source ion activation voltage set to 400 V. FIGS. 4B and 4C show the ion fragmentation efficiency (FE) for several high-mass ions, and demonstrate that the presently disclosed configuration exhibits improved FE. For example, the FE for m/z=1522 utilizing the previously known configuration may be about 28%, whereas the FE for m/z=1522 utilizing the presently disclosed configuration may be about 93%. FE may be determined formulas follows:

FE=[1−(ion signal intensity at 400 V/ion signal intensity at 0 V)]×100

In a typical example, the ionization device utilized in an ion source as disclosed herein may be an atmospheric pressure ionization (API) device. Examples of API ionization devices may include, but are not limited to, spray ionization devices (e.g., devices for electrospray ionization (ESI), probe electrospray ionization (PESI), desorption electrospray ionization (DESI), solvent-assisted ionization (SAI), matrix-assisted ionization (MAI), thermospray ionization, sonic spray ionization, ultrasonication-assisted spray ionization (UASI), etc.), atmospheric-pressure chemical ionization (APCI) devices, atmospheric-pressure photoionization (APPI) devices, atmospheric-pressure laser desorption ionization (AP-LDI) devices, atmospheric-pressure matrix-assisted laser desorption ionization (AP-MALDI) devices, atmospheric-pressure plasma-based devices, ambient ionization devices, etc. The sample to be ionized and analyzed may be introduced to the ion source by any suitable means, including hyphenated techniques in which the sample is an output of a pre-ionization analytical separation instrument such as, for example, a gas chromatography (GC), liquid chromatography (LC), or electrophoresis (e.g., capillary electrophoresis (CE) instrument.

In addition to the funnel-based ion trap described above, examples of other ion traps that may be utilized in a spectrometry system as disclosed herein may include, but are not limited to, ion traps based on two-dimensional (linear) and three-dimensional multipole electrode arrangements. Alternatively, the ionization device and ionization chamber provided may be configured to provide the functions of ion accumulation and pulsing, in which case a separate ion trap may not be provided.

An ion fragmentation device provided in a spectrometry system as disclosed herein may include a collision cell as described above, or may have a configuration other than a CID-based device. For example, the ion fragmentation device may be configured to perform electron capture dissociation (ECD), electron transfer dissociation (ETD), infrared multiphoton dissociation (HIVPD), etc.

In an example, a spectrometry system as disclosed herein may include a quadrupole mass filter as a first mass analyzer and a TOF analyzer as a second mass analyzer. More generally, however, various types of mass analyzers may be utilized in the spectrometry system. Examples may include, but are not limited to, multipole electrode structures (e.g., quadrupole mass filters, linear ion traps, three-dimensional Paul traps, etc.), electrostatic traps (e.g. Kingdon, Knight and ORBITRAP® traps), ion cyclotron resonance (ICR) or Penning traps (such as utilized in Fourier transform ion cyclotron resonance mass spectrometry (FT-ICR or FTMS)), electric field sector instruments, magnetic field sector instruments, etc.

An ion detector provided in a spectrometry system as disclosed herein may be, for example, an electron multiplier (EM), micro-channel plate (MCP) detector, a Faraday cup, etc.

As appreciated by persons skilled in the art, a spectrometry system as disclosed herein may include various other ion optics positioned along the ion path that are not specifically described above or shown in the drawing figures. Such ion optics may be configured for controlling or manipulating (e.g., focusing, shaping, steering, cooling, accelerating, decelerating, slicing, etc.) the ion beam, as appreciated by persons skilled in the art.

The controller 176 schematically depicted in FIG. 1 may represent one or more modules, control units, components, or the like configured to control, monitor and/or time the operation of various devices that may be provided in a spectrometry system as disclosed herein. As described above, the controller 176 may control, or execute a preprogrammed operation of, the voltage source 142 or 242 and consequently control the electric fields and collision energies realized in the reduced-pressure chamber 128 of the ion source 102 or 302 (FIGS. 1-3). The controller 176 may communicate with and control other devices that may be associated with the ion source 102 or 302 and the spectrometer 106 or 306 such as, for example, the ionization device, ion funnels and other ion guides, ion trap, IM analyzer (e.g., drift cell), mass filter, collision cell or other ion fragmentation device, TOF analyzer or other mass analyzer, ion detector, vacuum system, ion optics, sample introduction device, upstream LC, GC, or CE instrument, etc. One or more modules of the controller 176 may be, or may be embodied in, for example, a computer workstation, desktop computer, laptop computer, portable computer, tablet computer, handheld computer, mobile computing device, personal digital assistant (PDA), smartphone, etc.

The controller 176 may also schematically represent all electronic components not specifically shown in FIGS. 1-3 that may be needed for practical operation of the spectrometry system, such as, for example, voltage sources, timing controllers, clocks, frequency/waveform generators, processors, logic circuits, memories, databases, etc. The controller 176 may also be configured to receive the ion measurement signals from the ion detector and perform tasks relating to data acquisition and signal analysis as necessary to generate chromatograms, drift spectra, CCS spectra, and mass spectra characterization of the sample under analysis. The controller 176 may also be configured to provide and control a user interface that provides screen displays of spectrometric data and other data with which a user may interact. The controller 176 may also be configured to execute data processing algorithms such as feature finders. The controller 176 may include one or more reading devices on or in which a non-transitory or tangible computer-readable (machine-readable) medium may be loaded that includes instructions for performing all or part of any of the methods disclosed herein. For all such purposes, the controller 176 may be in electrical communication with various components of the spectrometry system via wired or wireless communication links (as partially represented by a dashed line between the controller 126 and the ion detector 150 in FIG. 1). Also for these purposes, the controller 176 may include one or more types of hardware, firmware and/or software, as appreciated by persons skilled in the art.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the controller 176 schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which may include, for example, one or more microprocessors, general purpose processors, combinations of processors, digital signal processors (DSPs), application specific integrated circuits (ASICs), or field-programmable gate arrays (FPGAs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the controller 176 shown in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium may be any non-transitory component that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) may be used herein to indicate a structural, functional, mechanical, electrical, signal, optical, magnetic, electromagnetic, ionic or fluidic relationship between two or more components or elements. As such, the fact that one component may be said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation of the invention being defined by the claims.

What is claimed is:

1. An ion source comprising:
an ionization chamber to be maintained at atmospheric-pressure;
a reduced-pressure chamber to be maintained at sub-atmospheric pressure; and
an ion transfer device comprising an inlet in the ionization chamber and an outlet in the reduced-pressure chamber,
wherein the ion transfer device defines an ion path from the inlet to the outlet, and
wherein the ion transfer device is positioned to emit ions and neutral gas molecules from the outlet as an expanding beam comprising a low-gas density zone enveloped by a high-gas density region that includes a gas density that is higher than the low-gas density zone.

2. The ion source according to claim 1, further comprising:
an electrode positioned in the reduced-pressure chamber at a gap distance from the outlet, wherein the electrode is to:
generate an electric field between the outlet and the electrode to accelerate ions emitted from the outlet to a collision energy effective to induce ion activation of the ions; and
position the electric field in overlapping relation to the low-gas density zone.

3. The ion source according to claim 2, wherein the outlet is positioned on an outlet axis, and the electrode comprises an aperture positioned on the outlet axis.

4. The ion source according to claim 1, further comprising a vacuum system to reduce the reduced-pressure chamber to the sub-atmospheric pressure.

5. The ion source according to claim 1,
wherein the ion transfer device comprises:
a main bore having an inside diameter smaller than an inside diameter of the outlet; and
a conical section fluidly coupling the main bore to the outlet, and
wherein the conical section has an inside diameter that increases from the inside diameter of the main bore to the inside diameter of the outlet.

6. The ion source of claim 5,
wherein the ion transfer device comprises:
a capillary tube through which the main bore extends; and
a cap mounted to or part of the capillary tube, and
wherein the cap comprises the conical section and the outlet.

7. The ion source according to claim 1, further comprising an ion guide in the reduced-pressure chamber and positioned along an ion guide axis.

8. The ion source according to claim 7, wherein the ion guide is to generate a radio frequency electric field effective to limit radial motion of ions relative to the ion guide axis.

9. The ion source according to claim 7, wherein the ion guide is to generate a direct-current potential gradient along the ion guide axis.

10. The ion source according to claim 7,
wherein the ion guide comprises an ion guide entrance and an ion guide exit spaced from the ion guide entrance along the ion guide axis, and
wherein the ion guide entrance surrounds at least a portion of an electrode positioned in the reduced-pressure chamber.

11. The ion source according to claim 7, wherein the ion guide is a first ion guide and the ion guide axis is a first ion guide axis, further comprising:
a second ion guide positioned along a second ion guide axis to receive ions from the first ion guide.

12. The ion source according to claim 1, further comprising an ionization device to produce ions in the ionization chamber from a sample by atmospheric-pressure ionization.

13. A spectrometry system, comprising:
an ionization chamber to be maintained at atmospheric-pressure;
a reduced-pressure chamber to be maintained at sub-atmospheric pressure;
an ion transfer device comprising an inlet in the ionization chamber and an outlet in the reduced-pressure chamber, wherein the ion transfer device defines an ion path from the inlet to the outlet; and
an electrode positioned in the reduced-pressure chamber at a gap distance from the outlet.

14. The spectrometry system of claim 13, further comprising:
a vacuum housing to receive ions from the reduced-pressure chamber; and
an ion analyzer in the vacuum housing.

15. The spectrometry system according to claim 14, wherein the ion analyzer comprises an ion mobility drift cell or a mass analyzer.

16. A method for analyzing a sample, the method comprising:
performing atmospheric-pressure ionization to produce ions from the sample in an ionization chamber;
transferring the ions from the ionization chamber to a reduced-pressure chamber maintained at a sub-atmospheric pressure; and
subjecting the ions emitted into the reduced-pressure chamber to an electric field that accelerates the ions to a collision energy that is effective to induce ion activation of the ions without voltage breakdown.

17. The method of claim 16, wherein the ions and neutral gas molecules are emitted into the reduced-pressure chamber as an expanding beam comprising a low-gas density zone enveloped by a high-gas density region that includes a gas density that is higher than the low-gas density zone, further comprising:
positioning the electric field in overlapping relation to the low-gas density zone.

18. The method of claim 17, wherein transferring the ions further comprises controlling the expanding beam such that the low-gas density zone transitions to a Mach disk.

19. The method of claim 16,
wherein transferring the ions further comprises emitting the ions from an outlet of an ion transfer device, and
wherein subjecting the ions emitted into the reduced-pressure chamber to the electric field further comprises imparting a potential difference between the outlet and an electrode in the reduced-pressure chamber to accelerate the ions to the collision energy.

20. The method of claim 16, wherein transferring the ions further comprises emitting the ions into an ion guide positioned in the reduced-pressure chamber.
